(19) United States
(12) Patent Application Publication
(10) Pub. No.: US 2009/0029892 A1
(43) Pub. Date: Jan. 29, 2009

(54) CLEANING SOLUTION FOR CLEANING SURFACE OF NOZZLE PLATE OF INKJET PRINTHEAD AND METHOD OF CLEANING SURFACE OF NOZZLE PLATE BY USING THE CLEANING SOLUTION

(75) Inventors: Tae-woon CHA, Seoul (KR); Tae-gyun KIM, Suwon-si (KR); Sung-woong KIM, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/934,931

(22) Filed: Nov. 5, 2007

(30) Foreign Application Priority Data
Jul. 26, 2007 (KR) 10-2007-0075115

(51) Int. Cl. C11D 9/26

(52) U.S. Cl. 510/170

(57) ABSTRACT

Provided are a cleaning solution for cleaning a surface of a nozzle plate of an inkjet printhead that prints an image by ejecting ink droplets through nozzles and a method of cleaning a surface of a nozzle plate by using the cleaning solution. The cleaning solution includes a solvent; and an additive comprising at least one of a leveling agent and a surfactant, which is added to the solvent.

### CROSS-REFERENCE TO RELATED APPLICATIONS

This application claims the benefit of Korean Patent Application No. 10-2007-0075115, filed on Jul. 26, 2007, in the Korean Intellectual Property Office, the disclosure of which is incorporated herein in its entirety by reference.

### BACKGROUND OF THE INVENTION

1. Field of the Invention

The present invention relates to an inkjet printhead, and more particularly, to a cleaning solution for cleaning a surface of a nozzle plate of an inkjet printhead and a method of cleaning a surface of a nozzle plate by using the cleaning solution.

2. Description of the Related Art

Inkjet printheads print an image having predetermined colors by ejecting tiny droplets of liquid ink at desired positions on a medium to be printed. The inkjet printheads are divided into two types according to a method of ejecting the ink. One is a thermal type that forms bubbles that eject the droplets of ink by using a heat source. The other is a piezoelectric type that ejects the droplets of ink by transforming piezoelectric materials and thereby applying pressure to the ink.

Recently, inkjet printheads are predominantly used for various industrial purposes as well as image printing. Examples of products made using inkjet printheads include color filters for liquid crystal display devices (LCDs), organic light emitting devices (OLEDs), and organic thin film transistors (OTFTs). Conventionally, color filters are manufactured by using a photolithography method. However, recently, due to the large scale production of display panels, the necessity for reducing manufacturing costs is increasing and thus substitutive technologies for the photolithography method are being developed. In particular, a technology of manufacturing color filters by using an inkjet method is popular.

FIG. 1 is a cross sectional view of a general piezoelectric inkjet printhead.

Referring to FIG. 1, the piezoelectric inkjet printhead includes a channel plate 10, a diaphragm 20, a nozzle plate 30, and a piezoelectric actuator 40. A manifold 11, a plurality of restrictors 12, and a plurality of pressure chambers 13 which form ink flow channels are formed in the channel plate 10. The diaphragm 20, which is transformed by the operation of the piezoelectric actuator 40, is bonded on an upper surface of the channel plate 10. The nozzle plate 30 in which a plurality of nozzles 31 are formed is bonded to the channel plate 10. The manifold 11 is a passage of ink flowing from an ink storage (not shown) into each of the pressure chambers 13 and the restrictors 12 are passages of the ink flowing from the manifold 10 to the pressure chambers 13. The pressure chambers 13 contain the ink to be ejected and are disposed on one side or both sides of the manifold 11. The nozzles 31 are formed so as to penetrate the nozzle plate 30 and are connected to all the pressure chambers 13. The diaphragm 20 is disposed on the upper surface of the channel plate 10 so as to cover the pressure chambers 13. The diaphragm 20 is transformed by the operation of the piezoelectric actuator 40 and thus provides pressure variations for ejecting the ink to each of the pressure chambers 13. The piezoelectric actuator 40 is composed of a lower electrode 41, a piezoelectric film 42, and an upper electrode 43 which are sequentially disposed on the diaphragm 20. The lower electrode 41 is formed on an entire surface of the diaphragm 20 and performs as a common electrode. The piezoelectric film 42 is formed on the lower electrode 41 so as to be disposed above the pressure chambers 13. The upper electrode 43 is formed on the piezoelectric film 42 and performs as a driving electrode that applies voltages to the piezoelectric film 42.

In the above-described inkjet printhead, surface processing of the nozzle plate 30 has direct influence upon ink ejecting performance, such as directionality and speed, of ink droplets ejected through the nozzles 31. That is, in order to improve the ink ejecting performance, ink-repellent processing has to be performed on a lower surface of the nozzle plate 30. In more detail, if the ink-repellent processing is performed, ink-wetting is prevented on the surface of the nozzle plate 30 and thus the directionality of the ink droplets may be improved. In general, a non-wetting coating film is formed on the surface of the nozzle plate 30.

Meanwhile, assuming that printing operation is performed by using the inkjet printhead, if ink remains around the nozzles 31 through which the ink droplets are externally ejected, the ink ejecting performance may deteriorate when the ink droplets are ejected next time. Accordingly, in order to prevent the above-described deterioration, the surface of the nozzle plate 30 is cleaned by a periodical maintenance process. However, even when the maintenance process is performed, directionality or volume of the ink droplets ejected through the nozzles 31 may vary whenever the maintenance process is performed. This is because the surface of the nozzle plate 30 is differently cleaned whenever the maintenance process is performed. Therefore, the surface of the nozzle plate 30 has to be perfectly cleaned to an initial state.

The maintenance process of the surface of the nozzle plate 30 is more important for an inkjet printhead using non-aqueous based ink that is generally used to manufacture a color filter, than an inkjet printhead using aqueous based ink. The surface tension of the non-aqueous based ink for a color filter is about 20˜30 mN/m, which is lower than the surface tension of the aqueous based ink. The viscosity of the non-aqueous based ink is about 8˜20 cps. However, the critical surface tension of the non-wetting coating film formed on the surface of the nozzle plate 30 is about 10 mN/m and thus the ink remaining on the surface of the nozzle plate 30 after ejecting the ink may not be removed easily.

Conventionally, the surface of the nozzle plate 30 of the inkjet printhead using the non-aqueous based ink is cleaned by wiping the surface of the nozzle plate 30 using fabric soaked by a solvent used for the non-aqueous based ink or by wiping the surface of the nozzle plate 30 using a blade or lint without a solvent. However, if a solvent is used, excessive use of the solvent may influence the non-aqueous based ink filled in the nozzles 31. If a blade or lint is used without a solvent, electrostatic charge may occur due to friction between the surface of the nozzle plate 30 and the blade or lint, and thus, the electrostatic charge may degrade the directionality of the ink droplets.

### SUMMARY OF THE INVENTION

The present invention provides a cleaning solution for cleaning a surface of a nozzle plate of an inkjet printhead and a method of cleaning a surface of a nozzle plate by using the cleaning solution, in which ink ejecting performance of an inkjet printhead may be improved by efficiently cleaning the surface of the nozzle plate.

According to an aspect of the present invention, there is provided a cleaning solution for cleaning a surface of a nozzle plate of an inkjet printhead that prints an image by ejecting ink droplets through nozzles, the cleaning solution including a solvent; and an additive comprising at least one of a leveling agent and a surfactant, which is added to the solvent.

The solvent may be the same solvent of ink used for the inkjet printhead. In this case, the solvent may be one of dipropylene glycol methyl ether acetate (DPMA), ethyl diglycol acetate (EDGAC), diethylene glycol monobutyl ether acetate (DGMA), and propylene glycol methyl ether acetate (PGMEA).

The leveling agent may be siloxane compound and the siloxane compound may include silicone polymer. Here, the silicone polymer may be polysiloxane including fluorocarbon.

The surfactant may be a polyester-based material, a polyacryl-based material, a polyurethane-based material, or a polycaprolactone-based material which comprises one of an amino group, a carboxyl group, a sulfone group, and a hydroxyl group.

The cleaning solution may be composed of components of ink used for the inkjet printhead except for a millbase, a binder, and a monomer. The content of the additive of the cleaning solution may be 0.0001˜10 wt %.

Ink used for the inkjet printhead may be non-aqueous based ink. In this case, the non-aqueous based ink may include ink used for manufacturing a color filter by using an inkjet method.

According to another aspect of the present invention, there is provided a method of cleaning a surface of a nozzle plate of an inkjet printhead that prints an image by ejecting ink droplets through nozzles, by using a cleaning solution, the cleaning solution including a solvent; and an additive comprising at least one of a leveling agent and a surfactant, which is added to the solvent.

The surface of the nozzle plate may be cleaned by periodically wiping the surface of the nozzle plate using a blade or fabric to which the cleaning solution is applied, after ink droplets are ejected from the inkjet printhead.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross sectional view of a general piezoelectric inkjet printhead;

FIG. 2 is a photographic image showing whether a surface of a non-wetting coating film formed on a nozzle plate is polluted or not when an ink droplet is dropped on the non-wetting coating film and then is gradually reduced;

FIG. 3 is a photographic image showing the result when a surface of the polluted non-wetting coating film illustrated in FIG. 2 is wiped by using the cleaning solution according to the present invention;

FIG. 4 is a photographic image showing the result when a surface of a nozzle plate of an inkjet printhead that ejects blue ink used for a color filter, is cleaned by using only a solvent; and

FIG. 5 is a photographic image showing the result when a surface of a nozzle plate of an inkjet printhead that ejects blue ink used for a color filter, is cleaned by using a cleaning solution according to the present invention.

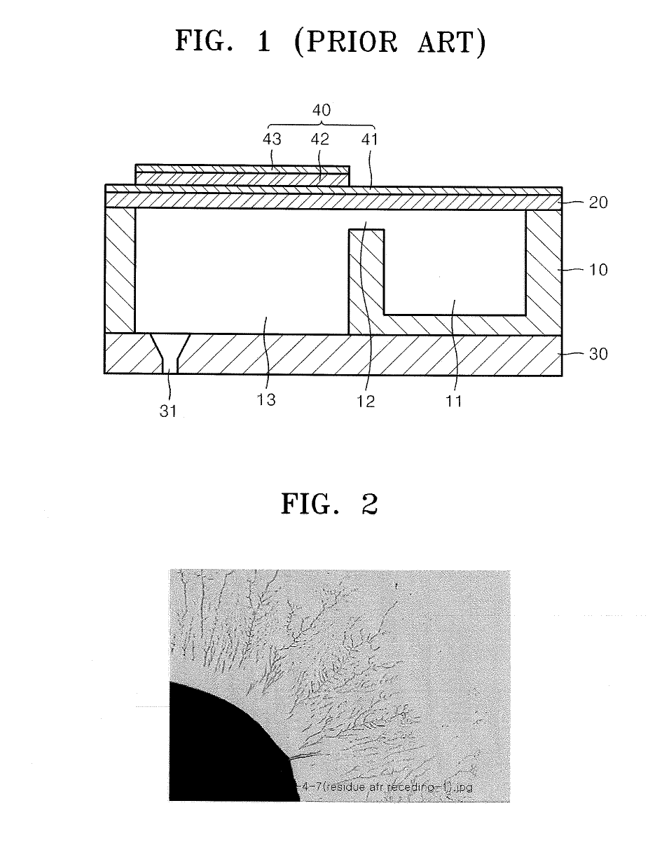

### DETAILED DESCRIPTION OF THE PREFERRED EMBODIMENTS

Hereinafter, the present invention will be described in detail by explaining embodiments of the invention.

The present invention provides a cleaning solution that may clean a surface of a nozzle plate of an inkjet printhead that prints an image by ejecting ink droplets through nozzles, to an initial state and thus may prevent the surface of the nozzle plate from being polluted by ink after the ink droplets are ejected. In more detail, the present invention uses a cleaning solution including a solvent and an additive to be added to the solvent which includes at least one of a leveling agent and a surfactant in order to clean the surface of the nozzle plate of the inkjet print head. The cleaning solution may be composed of components of ink used for the inkjet printhead except for a millbase, a binder, and a monomer. Therefore, the contents of the solvent and the additive of the cleaning solution may vary in accordance with the ink used for the inkjet printhead.

In more detail, the solvent of the cleaning solution may be the same solvent of the ink used for the inkjet printhead. For example, the solvent may be dipropylene glycol methyl ether acetate (DPMA), ethyl diglycol acetate (EDGAC), diethylene glycol monobutyl ether acetate (DGMA), or propylene glycol methyl ether acetate (PGMEA). The leveling agent may be a siloxane compound such as silicone polymer. Here, the silicone polymer may be polysiloxane including fluorocarbon. The surfactant may be a polyester-based material, a polyacryl-based material, a polyurethane-based material, or a polycaprolactone-based material which includes one of an amino group, a carboxyl group, a sulfone group, and a hydroxyl group. Here, the content of the additive to be added to the solvent may be approximately 0.0001˜10 wt %.

A method of cleaning a surface of a nozzle plate by using the above-described cleaning solution will now be described.

After ink droplets are ejected from an inkjet printhead, the nozzle plate may be cleaned by applying the cleaning solution including a solvent of ink used for the inkjet printhead and an additive that includes a leveling agent and/or a surfactant, to a blade or fabric and then wiping the surface of the nozzle plate in which nozzles are formed, by using the blade or fabric. Here, in general, a non-wetting coating film is formed on the surface of the nozzle plate in order to improve the directionality of the ink droplets ejected from the nozzles.

As such, if the surface of the nozzle plate is cleaned by using the cleaning solution according to the present invention, ink and pigments of the ink which remain on the surface of the nozzle plate may be completely removed by using a small amount of the cleaning solution. In more detail, the leveling agent or the surfactant included in the cleaning solution according to the present invention separates the ink and the pigments of the ink which remain on the surface of the nozzle plate from the nozzle plate. Accordingly, if the surface of the nozzle plate is wiped by using the cleaning solution, the ink and the pigments of the ink which remain on the surface of the nozzle plate are separated from the nozzle plate and then are clearly removed by moving together with the solvent. As a result, the surface of the nozzle plate is cleaned to an initial state before the ink droplets are ejected.

Results of tests performed by using the above-described cleaning solution will now be described with reference to FIGS. 2, 3, 4, and 5. The cleaning solution used for the tests was composed of 95 wt % of a DPMA solvent and 5 wt % of polysiloxane including fluorocarbon.

FIG. 2 is a photographic image showing whether a surface of a non-wetting coating film formed on a nozzle plate is polluted or not when an ink droplet is dropped on the non-wetting coating film and then is gradually reduced.

Referring to FIG. 2, after the ink droplet is ejected from an inkjet printhead, the non-wetting coating film of the nozzle plate is polluted by ink.

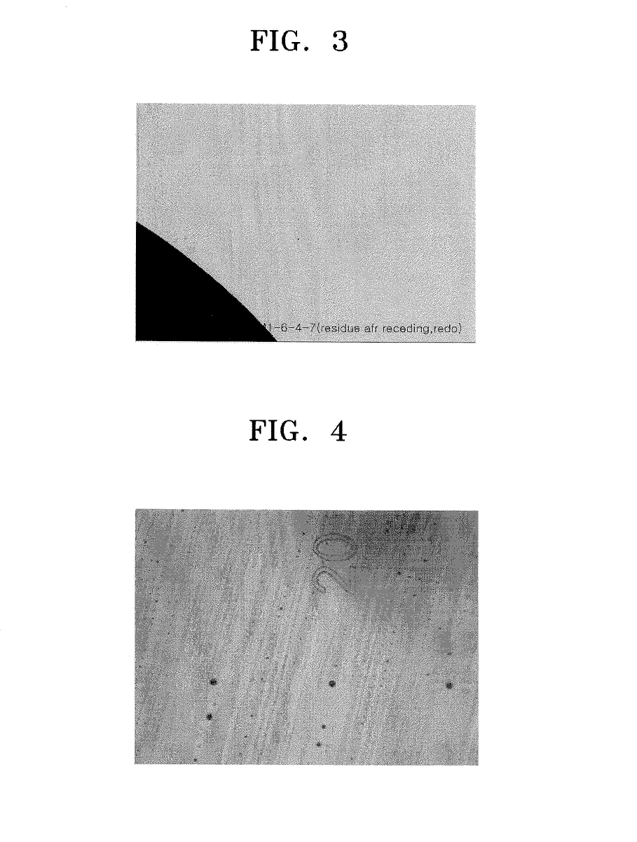

FIG. 3 is a photographic image showing the result when a surface of the polluted non-wetting coating film illustrated in FIG. 2 is wiped by using the cleaning solution according to the present invention.

Referring to FIG. 3, remainders on the surface of the non-wetting coating film are completely removed after surface of the non-wetting coating film is wiped by using the cleaning solution.

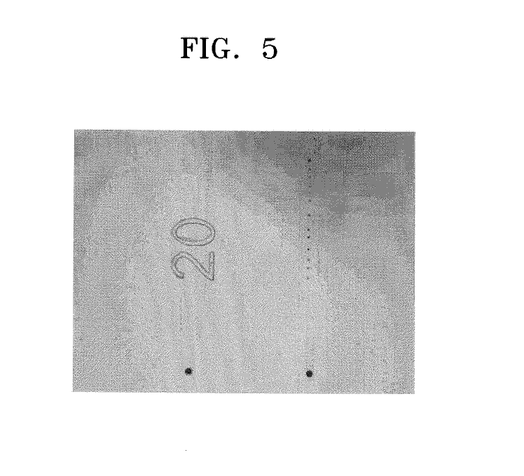

FIG. 4 is a photographic image showing the result when a surface of a nozzle plate of an inkjet printhead that ejects blue ink used for a color filter, is cleaned by using only a solvent. Here, the surface of the nozzle plate is cleaned by wiping the surface of the nozzle plate using polyester fabric to which the solvent of ink used for the inkjet printhead is applied. FIG. 5 is a photographic image showing the result when a surface of a nozzle plate of an inkjet printhead that ejects blue ink used for a color filter, is cleaned by using a cleaning solution according to the present invention. Here, the surface of the nozzle plate is cleaned by wiping the surface of the nozzle plate using polyester fabric to which the cleaning solution according to the present invention is applied.

Referring to FIGS. 4 and 5, when the surface of the nozzle plate is cleaned by using the cleaning solution according to the present invention, the performance of cleaning is greatly improved in comparison with the case when only the solvent is used.

The present invention may be mostly applied to piezoelectric inkjet printheads, but is not limited thereto. The present invention may also be applied to thermal inkjet printheads. In particular, the present invention may be usefully applied to inkjet printheads using non-aqueous based ink in which a surface of a nozzle plate is easily polluted after ink droplets are ejected through nozzles. A representative example of the non-aqueous based ink is ink used for manufacturing a color filter by using an inkjet method. However, the present invention is not limited thereto and may be applied to inkjet printheads using aqueous based ink.

As described above, according to the present invention, by periodically cleaning a surface of a nozzle plate using a cleaning solution including a solvent and a leveling agent or a surfactant after an inkjet printhead ejects ink droplets through nozzles, ink that remains on the surface of the nozzle plate may be efficiently removed. Thus, the surface of the nozzle plate may be cleaned to an initial state before the ink droplets are ejected. As a result, the ink ejecting performance of the inkjet printhead may be improved. Furthermore, the surface of the nozzle plate may be efficiently cleaned by using a small amount of the cleaning solution and the durability of a non-wetting coating film formed on the surface of the nozzle plate may be improved by minimizing a maintenance process.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A cleaning solution for cleaning a surface of a nozzle plate of an inkjet printhead that prints an image by ejecting ink droplets through nozzles, the cleaning solution comprising:
a solvent; and
an additive comprising at least one of a leveling agent and a surfactant, which is added to the solvent.

2. The cleaning solution of claim 1, wherein the solvent is the same solvent of ink used for the inkjet printhead.

3. The cleaning solution of claim 2, wherein the solvent is one of dipropylene glycol methyl ether acetate (DPMA), ethyl diglycol acetate (EDGAC), diethylene glycol monobutyl ether acetate (DGMA), and propylene glycol methyl ether acetate (PGMEA).

4. The cleaning solution of claim 1, wherein the leveling agent is a siloxane compound.

5. The cleaning solution of claim 4, wherein the siloxane compound comprises silicone polymer.

6. The cleaning solution of claim 5, wherein the silicone polymer is polysiloxane comprising fluorocarbon.

7. The cleaning solution of claim 1, wherein the surfactant is a polyester-based material, a polyacryl-based material, a polyurethane-based material, or a polycaprolactone-based material which comprises one of an amino group, a carboxyl group, a sulfone group, and a hydroxyl group.

8. The cleaning solution of claim 1, wherein the cleaning solution is composed of components of ink used for the inkjet printhead except for a millbase, a binder, and a monomer.

9. The cleaning solution of claim 1, wherein the content of the additive of the cleaning solution is 0.0001˜10 wt %.

10. The cleaning solution of claim 1, wherein ink used for the inkjet printhead is non-aqueous based ink.

11. The cleaning solution of claim 10, wherein the non-aqueous based ink comprises ink used for manufacturing a color filter by using an inkjet method.

12. A method of cleaning a surface of a nozzle plate of an inkjet printhead that prints an image by ejecting ink droplets through nozzles, by using a cleaning solution, the cleaning solution comprising:
a solvent; and
an additive comprising at least one of a leveling agent and a surfactant, which is added to the solvent.

13. The method of claim 12, wherein the surface of the nozzle plate is cleaned by periodically wiping the surface of the nozzle plate using a blade or fabric to which the cleaning solution is applied, after ink droplets are ejected from the inkjet printhead.

14. The method of claim 12, wherein the solvent is the same solvent of ink used for the inkjet printhead.

15. The method of claim 12, wherein the leveling agent is a siloxane compound.

16. The method of claim 12, wherein the surfactant is a polyester-based material, a polyacryl-based material, a polyurethane-based material, or a polycaprolactone-based material which comprises one of an amino group, a carboxyl group, a sulfone group, and a hydroxyl group.

17. The method of claim 12, wherein the cleaning solution is composed of components of ink used for the inkjet printhead except for a millbase, a binder, and a monomer.

18. The method of claim 12, wherein the content of the additive of the cleaning solution is 0.0001˜10 wt %.

19. The method of claim 12, wherein ink used for the inkjet printhead is non-aqueous based ink.

20. The method of claim 10, wherein the non-aqueous based ink comprises ink used for manufacturing a color filter by using an inkjet method.
